(19) United States
(12) Patent Application Publication
(10) Pub. No.: US 2013/0058008 A1
(43) Pub. Date: Mar. 7, 2013

(54) ELECTRODE ACTIVE MATERIAL COMPOSITION AND ELECTROCHEMICAL CAPACITOR INCLUDING THE SAME

(71) Applicants: Hak Kwan KIM, Seoul (KR); Jun Hee Bae, Seoul (KR); Ho Jin Yun, Gyeonggi-do (KR); Bae Kyun Kim, Gyeonggi-do (KR)

(72) Inventors: Hak Kwan KIM, Seoul (KR); Jun Hee Bae, Seoul (KR); Ho Jin Yun, Gyeonggi-do (KR); Bae Kyun Kim, Gyeonggi-do (KR)

(73) Assignee: SAMSUNG ELECTRO-MECHANICS CO., LTD., Suwon (KR)

(21) Appl. No.: 13/468,488

(22) Filed: May 10, 2012

(30) Foreign Application Priority Data
Sep. 6, 2011 (KR) 10-2011-0090172

(51) Int. Cl. H01G 9/042

(52) U.S. Cl. 361/500; 252/182.1

(57) ABSTRACT

An electrode active material composition, including: an electrode active material; a ketjen black subjected to hydrophilization treatment; and a water-based solvent, and an electrochemical capacitor including an electrode having a current collector coated with the composition. A hydrophilic group is attached on a surface of the ketjen black conducting powder having very strong hydrophobicity, through hydrophilic treatment, and thus, dispersibility of an active material of a carbon material such as activated carbon, and the conducting agent, can be improved when an electrode using a water-based solvent is prepared, with the result that an electrode having improved flowability and uniformity of electrode active material slurry can be prepared.

### CROSS REFERENCE(S) TO RELATED APPLICATIONS

This application claims the benefit under 35 U.S.C. Section 119 of Korean Patent Application Serial No. 10-2011-0090172, entitled “Electrode Active Material Composition and Electrochemical Capacitor Including the Same” filed on Sep. 6, 2011, which is hereby incorporated by reference in its entirety into this application.

### BACKGROUND OF THE INVENTION

1. Technical Field

The present invention relates to an electrode active material composition for an electrochemical capacitor and an electrochemical capacitor including the same.

2. Description of the Related Art

In general, an electronic component called a capacitor stores electricity in a physical mechanism without chemical reaction or phase change, and functions to collect and then send out the electricity to stabilize electric current within a circuit. This capacitor has a very short charging and discharging time, long lifespan, and very high output density, but is limited in the use as an energy storage device due to very small energy density thereof.

In contrast, a secondary battery can store high-density energy, and has been used as an energy storage medium for portable electronic applications, such as a notebook, a cellular phone, a PDA, and the like. A lithium ion battery is called a byword for the secondary battery.

There is also an electrochemical capacitor, which expresses medium characteristics between the capacitor and the secondary battery and thus to be used as a storage medium of an electronic application requesting high energy density and high output density. The electrochemical capacitor is also called a supercapacitor, an electrical double layer capacitor (EDLC), an ultracapacitor, and the like.

The electrochemical capacitor is potentially applicable as various fields of energy storage media, such as wind power generation, a hybrid electric vehicle (HEV), an electric vehicle (EV), and the like, and thus receives explosive interests over the world.

The most important core of the supercapacitor is an electrode material. The electrode material needs to have a high specific surface area above all, large electric conductivity so that charges make the minimum voltage drop distribution at an electrode, electrochemical stability at a predetermined potential, and low price for commercialization.

These supercapacitors can be largely divided into three types of supercapacitors depending on the electrode and mechanism.

First, there is an electrical double layer capacitor (EDLC), which uses an activated carbon for an electrode and has a mechanism of electric double layer charging or electrostatic adsorption.

Second, there is a pseudocapacitor or a redox capacitor which uses transition metal oxide or conductive polymer as an electrode material and has a mechanism of pseudo-capacitance from chemical oxidation and reduction reaction.

Third, there is a hybrid capacitor having medium characteristics between the electric double layer capacitor and the redox capacitor.

In addition, the supercapacitor, particularly the EDLC, which is most commonly used currently, is operated by an electrochemical mechanism in which a voltage with several volts is applied to both ends of an electrode of a unit cell, and thus, ions within an electrolytic solution moves along electric fields and adsorbs a surface of the electrode.

Meanwhile, a basic structure of this supercapacitor consists of a porous electrode, an electrolytic solution, a current collector, and a separator.

The porous electrode may be formed by mixing an active material, a conductive material, a binder, a solvent, and other additives to prepare a slurry and coating the slurry on the current collector. Activated carbon is mainly used as the active material of the electrode while it has porosity in a surface thereof. Considering that specific capacitance is proportional to a specific surface area, the activated carbon increases energy density due to high capacitance of an electrode material.

Furthermore, while the active material slurry is coated and dried on the current collector, the binder is attached between the active material and the active material and between the active material and the current collector to form the electrode. The binder is one of the important factors in determining a performance of the capacitor. If the performance of the binder is dropped or an appropriate amount of binder is not contained within the electrode, it is difficult to form a film with uniform thickness at the time of coating the electrode. Furthermore, the active material becomes detached from the active material or the current collector, which decreases a capacitance of the capacitor or increases an inner resistance, even after the capacitor is configured. In contrast, if the amount of the binder is excessively large, the amount of active material within the electrode is reduced, with the result that the capacitance of the capacitor is deteriorated, or the inner resistance is increased because of electric properties of polymer which is mostly an electrical nonconductor.

Furthermore, a degree at which a specific surface area of an electrode of the electrical double layer capacitor actually contributes to express capacitance is 20 to 30%, which is less than half of the total capacitance. Therefore, when the active material and the conductive agent are not well dispersed, the active material and the conductive agent, individually, agglomerate together within the electrode. In this case, a dead volume becomes increased within an active material slurry so much, with the result that the capacitance is not expressed and impregnation with the electrolytic solution does not sufficiently take place on the entire surface of the electrode.

Therefore, for forming the electrode for the electrochemical capacitor, an appropriate content of binder, uniform dispersion of the active material and the conductive agent, improvement of impregnation with the electrolytic solution, and the like are very important.

### SUMMARY OF THE INVENTION

An object of the present invention is to provide a composition for an electrode active material composition usable in an electrochemical capacitor having low resistance and high capacitance since an electrode active material and a conductive material have improved dispersibility in a water-based solvent.

Another object of the present invention is to provide an electrochemical capacitor using the electrode active material composition.

According to an exemplary embodiment of the present invention, there is provided an electrode active material composition, including: an electrode active material; a ketjen black subjected to hydrophilization treatment; and a water-based solvent.

The electrode active material may be at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor grown carbon fiber (VGCF), and graphene.

The electrode active material may be activated carbon having a specific surface area of 1,500 to 3000 m²/g.

The hydrophilization treatment of the ketjen black may be performed by using a material including at least one polar group selected from the group consisting of —N—, —O—, C═N, amino, cyclic amide, carboxyl, quinone, hydroxy, carbonyl, carboxylic anhydride, and lactone.

The material including the polar group may be at least one selected from the group consisting of nitric acid, carboxylic acid, and sodium hydroxide.

The electrode active material composition may include 75 to 85 wt % of the electrode active material, 8 to 12 wt % of the ketjen black subjected to hydrophilization treatment, and 5 to 10 wt % of a binder.

According to another exemplary embodiment of the present invention, there is provided an electrochemical capacitor, including: an electrode having a current collector coated with the electrode active material composition; a separator; and an electrolytic solution.

The electrode may be used as any one selected from a cathode and an anode of the electrochemical capacitor, or both thereof.

### DESCRIPTION OF THE PREFERRED EMBODIMENTS

Hereinafter, the present invention will be described in more detail.

Terms used in the present specification are for explaining the embodiments rather than limiting the present invention. As used herein, unless explicitly described to the contrary, a singular form includes a plural form in the present specification. Also, used herein, the word “comprise” and/or “comprising” will be understood to imply the inclusion of stated constituents, steps, operations and/or elements but not the exclusion of any other constituents, steps, operations and/or elements.

The present invention is directed to an electrode active material composition and an electrochemical capacitor including the same.

In the electrode active material composition of the present invention, dispersibility of an electrode active material and a conducting agent is improved, and thus, flowability of an electrode active material slurry is improved in a water-based solvent. Specifically, the electrode active material composition is characterized by including an electrode active material, a ketjen black subjected to hydrophilization treatment, and a water-based solvent.

In the electrode active material composition according to the present invention, a ketjen black subjected to hydrophilization treatment is preferably used as the conducting agent.

Among several conducting agents, the ketjen black has an air space rate of 78%, a primary particle diameter of 34 nm, and 110×10¹⁵ piece/g in a number of primary particles per unit weight. Compared with the existing acetylene black having an air space rate of 22%, a primary particle diameter of 43 nm, and 16×10¹⁵ piece/g in the number of primary particles per unit weight, the ketjen black is known to have conductivity, which is 3 to 5 times superior to the acetylene black, but also known to have very high hydrophobicity. Accordingly, the ketjen black is usable in the electrode active material using a non-water-based solvent which is an organic solvent, but still has a limitation in application to a factual product using a water-based solvent due to high hydrophobicity in spite of high conductivity.

Accordingly, in the present invention, a surface of a ketjen black powder was subjected to hydrophilization treatment, in order to use the ketjen black having high electric conductivity as a conducting agent of an electrode using the water-based solvent.

The hydrophilization treatment of the ketjen black is performed by using a material including at least one polar group selected from the group consisting of —N—, —O—, C═N, amino, cyclic amide, carboxyl, quinone, hydroxy, carbonyl, carboxylic anhydride, and lactone.

Specific examples of the material including the polar group may include at least one selected from the group consisting of nitric acid, carboxylic acid, and sodium hydroxide, but not limited thereto.

The hydrophilization treatment of the ketjen black may be performed by chemical hydrophilization treatment using a method of adding the ketjen black to the material including the polar group and stirring it at an appropriate temperature for an appropriate time period, or may be easily performed by liquid phase oxidation. However, any method can be used as long as the polar group can be attached to a surface of the ketjen black.

When the ketjen black subjected to hydrophilization treatment is used as the conducting agent, a carbon material (for example, activated carbon), which is an electrode active material having basically hydrophobic tendency, is homogeneously mixed in an electrode active material slurry containing a water-based solvent as a base, thereby minimizing resistance of an electrode itself.

In addition, a case where this hydrophilization treatment is performed on the conducting agent, is more advantageous than, a case where super-P or acetylene black, which is the existing conducting agent, is used and a binder resin, such as, carboxymethylcellulose (CMC), styrene-butadiene rubber (SBR), or polyvinlypyrolidone (PVP), and activated carbon are added to aqueous slurry together with this, in view of capacitance and resistance. In other words, when the same content of active material and conducting agent are used, flowability of a hydrophobic active material and a conducting agent in water is increased, and thus, a dead surface of the active material is largely decreased.

In addition, the loss in the number of primary particles, which consists of conducting crystallites, per unit weight, is small, and this can contribute to reduction in resistance. In other words, the ketjen black is about 5 to 7 times larger than the existing conducting agent such as acetylene black in view of the number of primary particles per unit weight, but in the ketjen black, an agglomeration degree among particles is too large, that is, hydrophobicity is very strong, with the result that the large number of particles has little effect at the time of preparing aqueous slurry and conductivity is rather dropped. Therefore, when flowability in water base is obviously improved, an increase characteristic in conductivity caused by the large number of primary particles can be reflected as a coating characteristic.

Therefore, the electrode using the electrode active material enables expression of an electrochemical capacitor having low resistance and high output due to uniform dispersion of the active material and the conducting agent.

As the electrode active material used in the present invention, at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor grown carbon fiber (VGCF), and graphene may be preferably used.

According to an exemplary embodiment of the present invention, it is preferable to use activated carbon having a specific surface area of 1,500 to 3,000 m²/g, of the electrode active materials.

Meanwhile the electrode active material composition according to the present invention may include 75 to 85 wt % of an electrode active material, 8 to 12 wt % of a ketjen black subjected to hydrophilization treatment, 5 to 10 wt % of a binder.

In particular, the ketjen black subjected to hydrophilization treatment is preferably contained in 8.0 to 12.0 wt % of the entire active material composition. If the content of the ketjen black deviates from the range, a reduction in capacitance per unit weight or unit volume may occur, unfavorably.

In addition, as the conducting agent, in addition to ketjen black subjected to hydrophilization treatment, a conducting powder, such as, super-P, acetylene black, carbon black, or graphite, may be contained in 5.0 to 8.0 wt %, based on the entire electrode active material composition. These two kinds of conducting agents are added, thereby improving electrode density, and thus, it can be anticipated that capacitance of electrode per unit volume and conductivity are improved.

The electrode active material composition according to the present invention may include an additive including a binder resin within a range where dispersibility or flowability of the electrode active material composition of the present invention is not affected, in addition to the electrode active material, the conducting agent, and the water-based solvent.

Examples of the binder resin may include at least one selected from a fluorine-based resin, such as polytetrafluoroethylene (PTFE), polyvinylidene fluoride (PVdF), or the like; a thermoplastic resin, such as polyimide, polyamideimide, polyethylene (PE), polypropylene (PP), or the like, a cellulose-based resin, such as carboxymethylenecellulose (CMC) or the like; a rubber-based resin, such as styrene-butadiene rubber (SBR) or the like; and a mixture thereof, but particularly not limited thereto. Any binder resin that can be used for common electrochemical capacitors may be used.

The electrode active material composition according to the present invention may be prepared by adding the electrode active material, the ketjen black subjected to hydrophilization treatment, the binder resin, and the like to the water-based solvent in predetermined contents, followed by stirring. In the present invention, a surface of the ketjen black having excellent conductivity is subjected to hydrophilization treatment, and thus, dispersibility of the ketjen black with other components within the electrode active material slurry, particularly the electrode active material can be excellent.

Further, the present invention can provide an electrochemical capacitor including an electrode in which the electrode active material composition is coated on a current collector, a separator, and an electrolytic solution.

The electrode according to the present invention may be used as any one selected from a cathode and an anode of an electrochemical capacitor, or both thereof.

The cathode and the anode may be prepared by coating the electrode active material composition on a cathode current collector and an anode current collector in a predetermined thickness, and a coating method of the electrode active material composition is not particularly limited.

In addition, a mixture of the electrode active material, the conducting agent, and the solvent may be molded in a sheet shape by using the binder resin, or a molded sheet extruded by an extrusion method may be attached to the current collector by using a conductive adhesive.

Any material used in the existing electric double-layer capacitor or lithium ion battery may be used for the cathode or anode current collector. Examples of the material may include at least one selected from a group consisting of aluminum, stainless, titanium, tantalum, and niobium, and aluminum is preferably used among them. An example of the current collector may include one having a hole penetrating front and rear surfaces, such as, an etched metal foil, an expanded metal, a punching metal, a net, foam, or the like, as well as a metal foil. The current collector may preferably have a thickness of about 10 to 300 μm.

As the separator according to the present invention, any material used in the existing electric double-layer capacitor or lithium ion battery may be used, and, for example, may be a microporous film prepared from at least one polymer selected from the group consisting of polyethylene (PE), polypropylene (PP), polyvinylidene fluoride (PVdF), polyvinlylidene chloride, polyacrylonitrile (PAN), polyacrylamide (PAAm), polytetrafluoro ethylene (PTFE), polysulfone, polyethersulfone (PES), polycarbonate (PC), polyamide (PA), polyimide (PI), polyethylene oxide (PEO), polypropylene oxide (PPO), cellulose-based polymer, and polyacryl-based polymer. Also, a multilayer film obtained by polymerizing the microporous film may be used as the separator, and the cellulose-based polymer may be preferably used among them. The separator preferably has a thickness of 15 to 35 μm, but is not limited thereto.

As the electrolytic solution of the present invention, an organic electrolytic solution including a nonlithium salt, such as a spiro-based salt, TEABF4, TEMABF 4, or the like, or a lithium salt, such as LiPF₆, LiBF₄, LiCLO₄, LiN(CF₃SO₂)₂, CF₃SO₃Li, LiC(SO₂CF₃)₃, LiAsF₆, LiSbF₆, or the like, or a mixture thereof may be used. Examples of the solvent may include at least one selected from the group consisting of an acrylonitrile-based solvent, ethylene carbonate, propylene carbonate, dimethyl carbonate, ethylmethyl carbonate, sulforane, and dimethoxyethane, but are not limited thereto. Electrolytic solutions obtained by combining these solutes and solvents have high withstand voltage and high electric conductivity. The concentration of electrolyte in the electrolytic solution is preferably 0.1 to 2.5 mol/L, 0.5˜2 mol/L.

A laminate film including aluminum, which is commonly used in a secondary battery and an electrical double layer capacitor, is preferably used as a case (an exterior part) of the electrochemical capacitor of the present invention, but is not particularly limited thereto.

The electrochemical capacitor according to the present invention may be more preferably used in the electric double layer capacitor, but is not particularly limited thereto.

Hereinafter, exemplary embodiments of the present invention will be described in detail. The following examples are only for illustrating the present invention, and the scope of the present invention should not be interpreted as being limited by these examples. In addition, specific compounds are used in the following examples, but it is obvious to those skilled in the art that equivalents thereof can exhibit the same or similar degrees of effects.

### EXAMPLE 1

### Preparation of Electrode Active Material Composition

1) Preparation of Ketjen Black Subjected to Hydrophilization Treatment

For hydrophilization treatment, 12 g of ketjen black and 500 mL of nitric acid solution were put into a three-neck flask, and surface treatment was performed by stirring the mixture at 90 to 100□ for 4 hours. Afterthat, in order to remove residual nitric acid, the resultant material was washed with distilled water until pH of 7 was reached, and then dried in an oven at 120□ for 48 hours.

2) Preparation of Electrode Active Material Slurry

85 g of activated carbon (specific surface area: 2550 m²/g) subjected to alkali activation treatment, 12 g of the ketjen black subjected to hydrophilization treatment, which is prepared in the above step 1), as a conducting agent, and 3.5 g of CMC, 12.0 g of SBR, and 5.5 g of PTFE, as a binder, were mixed with 225 g of water, followed by stirring, thereby preparing an electrode active material slurry.

### EXAMPLE 2

### Preparation of Electrode Active Material Composition

1) Preparation of Ketjen Black Subjected to Hydrophilization Treatment

For hydrophilization treatment, 12 g of ketjen black and 500 mL of carboxylic acid solution were put into a three-neck flask, and surface treatment was performed by stirring the mixture at 90 to 100□ for 2 hours. Afterthat, in order to remove residual nitric acid, the resultant material was washed with distilled water until pH of 7 was reached, and then dried in an oven at 120□ for 48 hours.

2) Preparation of Electrode Active Material Slurry

An electrode active material slurry was prepared by the same method as Example 1, except that the prepared ketjen black subjected to hydrophilization treatment was used.

### COMPARATIVE EXAMPLE 1

85 g of activated carbon (specific surface area: 2550 m²/g) subjected to alkali activation treatment, 18 g of pure super-P subjected to no treatment, as a conducting agent, and 3.5 g of CMC, 12.0 g of SBR, and 5.5 g of PTFE, as a binder, were mixed with 225 g of water, followed by stirring, thereby preparing an electrode active material slurry.

### EXAMPLES 3 AND 4, COMPARATIVE EXAMPLE 2

### Manufacture of Electrochemical Capacitor

1) Preparation of Electrode

The electrode active material slurry according to each of Examples 1 and 2 and Comparative Example 1 was coated on an aluminum etching foil with a thickness of 20 μm using a comma coater, followed by temporary drying, and then cut into electrodes with a size of 50 mm×100 mm. The electrode had a cross-sectional thickness of 60 μm. The electrode was dried under vacuum at 120□ for 48 hours, before assembling of a cell.

2) Preparation of Electrolytic Solution

Spiro-based salt was dissolved in an acrylonitrile-based solvent to a concentration of 1.3 mol/L, thereby preparing an electrolytic solution.

3) Assembling of Capacitor Cell

A separator (TF4035 from NKK, cellulose-based separator) was inserted between the prepared electrodes (cathode and anode), followed by impregnation with the electrolytic solution, and then the resulting structure was put and sealed in a laminate film case.

### EXPERIMENTAL EXAMPLE

### Evaluation on Capacitance of Electrochemical Capacitor Cell

Under the condition of constant temperature of 25□, the cell was charged to 2.5V at a current density of 1 mA/cm² in a constant current-constant voltage mode, and then kept for 30 minutes. Then, the cell was discharged at a constant current of 1 mA/cm² three times, and then capacitance at the last cycle was measured. The results were tabulated in Table 1.

Resistance property of each cell was measured by an ampere-ohm meter and an impedance spectroscopy, and the results were tabulated in Table 1.

TABLE 1

| | Initial | Resistance |
|---|---|---|
| | capacitance (F) | (AC ESR, mΩ) |
| Comparative | 10.55 | 19.11 |
| example 2 | | |
| Example 3 | 13.33 | 12.33 |
| Example 4 | 12.98 | 12.47 |

As seen from the results of Table 1, an electrochemical capacitor (EDLC cell) according to Comparative Example 2, which includes an electrode prepared by using the electrode active material slurry according to Comparative Example 1, which has a general composition of the electrode active material slurry, had capacitance of 10.55 F, and resistance of 19.11 mΩ at this time.

In contrast, electrochemical capacitors (EDLC cell) according to Examples 3 and 4, which include electrodes prepared by using the electrode active material slurries according to Examples 1 and 2, which contain the ketjen black material subjected to hydrophilization treatment as a conducting agent, had capacitances of 13.33 F and 12.98 F, respectively, and resistances of 12.33 mΩ and 12.47 mΩ, respectively.

From these results, it can be seen that an electrode having a reduced difference in resistance per unit volume can be prepared by improving dispersibility in a water base of the ketjen black conducting agent, and thus, a cell exhibiting excellent conductivity, low resistance, and high capacitance can be manufactured.

According to the present invention, a hydrophilic group is attached on a surface of the ketjen black conducting powder having very strong hydrophobicity, through hydrophilic treatment, and thus, dispersibility of an active material of a carbon material such as activated carbon, and the conducting agent, can be improved when an electrode using a water-based solvent is prepared, with the result that an electrode having improved flowability and uniformity of electrode active material slurry can be prepared.

Therefore, an electrochemical capacitor including the electrode can express low resistance and high output due to uniform dispersion of the active material and the conducting agent.

While the present invention has been shown and described in connection with the embodiments, it will be apparent to those skilled in the art that modifications and variations can be made without departing from the spirit and scope of the invention as defined by the appended claims.

What is claimed is:

1. An electrode active material composition, comprising:
an electrode active material;
a ketjen black subjected to hydrophilization treatment; and
a water-based solvent.

2. The electrode active material composition according to claim 1, wherein the electrode active material is at least one carbon material selected from the group consisting of activated carbon, carbon nanotube (CNT), graphite, carbon aerogel, polyacrylonitrile (PAN), carbon nanofiber (CNF), activated carbon nanofiber (ACKF), vapor grown carbon fiber (VGCF), and graphene.

3. The electrode active material composition according to claim 1, wherein the electrode active material is activated carbon having a specific surface area of 1,500 to 3000 m²/g.

4. The electrode active material composition according to claim 1, wherein the hydrophilization treatment of the ketjen black is performed by using a material including at least one polar group selected from the group consisting of —N—, —O—, C═N, amino, cyclic amide, carboxyl, quinone, hydroxy, carbonyl, carboxylic anhydride, and lactone.

5. The electrode active material composition according to claim 4, wherein the material including the polar group is at least one selected from the group consisting of nitric acid, carboxylic acid, and sodium hydroxide.

6. The electrode active material composition according to claim 1, wherein the electrode active material composition includes 75 to 85 wt % of the electrode active material, 8 to 12 wt % of the ketjen black subjected to hydrophilization treatment, and 5 to 10 wt % of a binder.

7. An electrochemical capacitor, comprising:
an electrode having a current collector coated with the electrode active material composition according to claim 1;
a separator; and
an electrolytic solution.

8. The electrochemical capacitor according to claim 7, wherein the electrode is used as any one selected from a cathode and an anode, or both thereof.
